(19) United States
(12) Patent Application Publication
(10) Pub. No.: US 2014/0190961 A1
(43) Pub. Date: Jul. 10, 2014

(54) COOKING APPARATUS

(71) Applicant: Panasonic Corporation, Kadoma-shi, Osaka (JP)

(72) Inventors: Kouji Kanzaki, Shiga (JP); Hisahiro Nishitani, Shiga (JP); Shinichi Yamane, Osaka (JP)

(21) Appl. No.: 14/239,678

(22) PCT Filed: Oct. 12, 2012
(86) PCT No.: PCT/JP2012/006569

§ 371 Date: Feb. 19, 2014

(30) Foreign Application Priority Data
Oct. 13, 2011 (JP) 2011-225581

(51) Int. Cl. H05B 6/64

(52) U.S. Cl. CPC H05B 6/6444
USPC 219/758

(57) ABSTRACT

A cooking apparatus 1 includes: a heating chamber which accommodates an object to be heated; an interior lamp illuminates the heating chamber; a control unit which supplies power to the interior lamp; and an operation unit which operates the control unit. The interior lamp is formed with an LED board on which a plurality of LED elements are mounted, and the control unit supplies power to only a part of the plurality of LED elements during cooking.

### TECHNICAL FIELD

The present invention relates to a cooking apparatus using an LED for an interior lamp, and more particularly to a cooking apparatus that is effective for energy reduction to reduce electric power consumption during cooking which occupies most of time required for completing cooking in business use in which an interior of a heating chamber is not usually viewed in the middle of the cooking.

### BACKGROUND ART

The heating cooking device of this type includes high frequency generating means (a magnetron) for outputting a high frequency wave, and has spread rapidly as a microwave oven which can efficiently heat an object to be heated in a heating chamber in a short time. In recent years, while energy reduction performance is required, it is acknowledged to change an interior lamp for lighting an interior of the heating chamber from a bulb to an LED, thereby reducing electric power consumption (for example, see Patent Document 1).

### RELATED ART DOCUMENTS

### Patent Documents

Patent Document 1: JP-A-2003-139336

### SUMMARY OF THE INVENTION

### Problem to be Solved by the Invention

A cooking apparatus mainly used for business purpose such as in a convenience store is frequently used for heat cooking and is required to increase further energy reduction performance and durability performance. In the convenience store, particularly, the cooking apparatus is often located behind a reception counter, and a salesperson turns his (her) back on the cooking apparatus in order to serve a customer after starting cooking. For this reason, the cooking is rarely checked during heating, and illumination by the interior lamp is not always required during the cooking.

The invention solves the problems of the related art, and an object thereof is to provide a cooking apparatus capable of controlling the number of turned-ON LEDs serving as an interior lamp which perform illumination during cooking, and reducing electric power consumption during an operation of the cooking apparatus, thereby enhancing energy reduction performance and durability performance.

### Means for Solving the Problem

In order to solve the problems of the related art, the present invention provides a cooking apparatus including: a heating chamber which accommodates an object to be heated; an interior lamp which illuminates the heating chamber; a control unit which controls the interior lamp; and an operation unit which operates the control unit, wherein the interior lamp is formed by a board on which a plurality of LED elements are mounted, and wherein the control unit performs lighting control of LED such that lighting control at start and end of cooking is different from that in a middle of the cooking.

By changing the control of the LED in the middle of the cooking, that is, for a period of time in which the cooking is not checked while a salesperson serves a customer after starting the cooking in a convenience store, it is possible to reduce electric power consumption.

### Advantages of the Invention

The cooking apparatus according to the invention performs the lighting control of the LED such that lighting control at time of start and end of the cooking is different from that in the middle of the cooking, thereby reducing the electric power consumption in the middle of the cooking, that is, for the period of time in which a user such as a convenience store does not check the cooking. Consequently, it is possible to enhance energy reduction performance. Since a lighting time for the LED is also shortened, it is also possible to improve durability.

### BRIEF DESCRIPTION OF THE DRAWINGS

FIG. 1 is a perspective view showing a cooking apparatus with a door opened according to a first embodiment of the invention.

FIG. 2 is a perspective view showing a main part of a structure of an attaching member for an interior lamp in the cooking apparatus according to the first embodiment of the invention.

FIG. 3 is a schematic view showing a board on which an LED is mounted in the cooking apparatus according to the first embodiment of the invention.

FIG. 4 is a block diagram showing the cooking apparatus according to the first embodiment of the invention.

FIG. 5 is a flowchart showing the simplest cooking of the cooking apparatus according to the first embodiment of the invention.

### MODE FOR CARRYING OUT THE INVENTION

In a first aspect of the invention, there is provided a cooking apparatus including: a heating chamber which accommodates an object to be heated; an interior lamp which illuminates the heating chamber; a control unit which controls the interior lamp; and an operation unit which operates the control unit, wherein the interior lamp is formed by a board on which a plurality of LED elements are mounted, and wherein the control unit performs lighting control of LED such that lighting control at start and end of cooking is different from that in a middle of the cooking. By reducing electric power consumption in the middle of the cooking during which a user such as a convenience store does not check the cooking, it is possible to enhance energy reduction performance. Further, since a lighting time for the LED is also shortened, it is also possible to improve durability.

Further, brightness of the interior lamp is changed when time comes near the end of the cooking. Therefore, even when a plurality of cooking apparatuses are operated at the same time, it is possible to easily find any of the cooking apparatuses which will end the cooking soon.

In a second aspect of the invention, particularly, the control unit in the first aspect of the invention sets a number of the LED elements turning-ON in the interior lamp such that a number of turned-ON LED elements at time of the start and end of the cooking is different from that in the middle of the cooking. Consequently, the brightness of the interior lamp is changed by switching a circuit of the board having the LED elements mounted thereon is switched, and it is possible to provide a simple, reliable and inexpensive structure.

In a third aspect of the invention, particularly, the operation unit according to the first or second aspect of the invention includes a dedicated key for operating the interior lamp, whereby brightness of the interior lamp can be freely changed when an interior of the heating chamber is to be checked.

Embodiments according to the present invention will be described below with reference to the drawings. The invention is not limited to the embodiments.

### First Embodiment

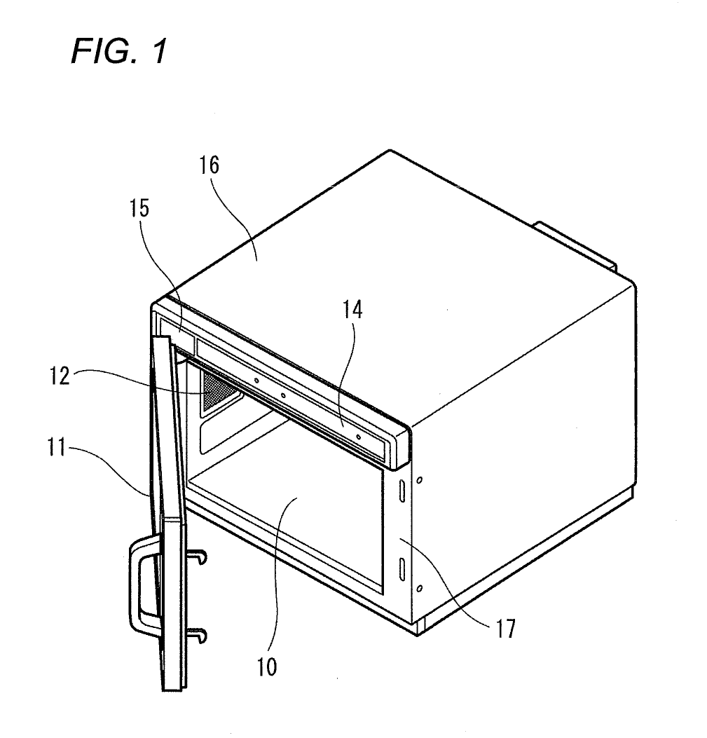

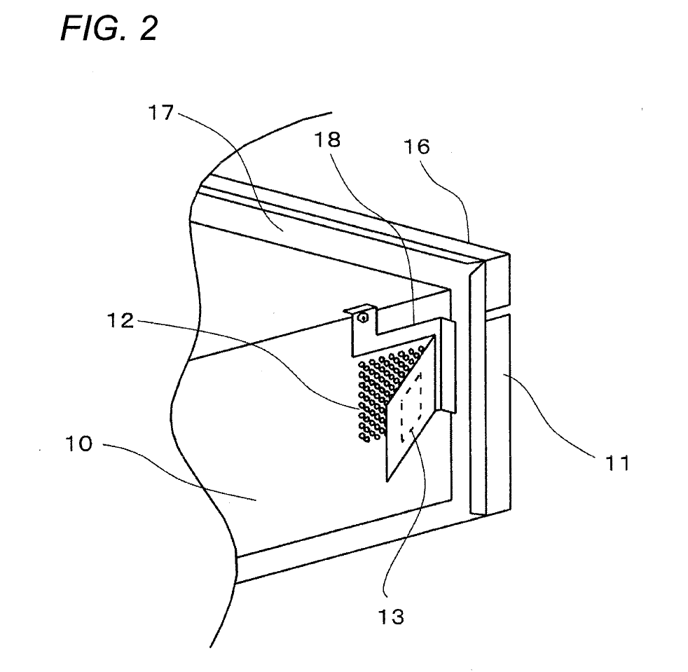

FIG. 1 is a perspective view showing a cooking apparatus with a door opened according to a first embodiment of the invention, and FIG. 2 is a perspective view showing a main part of a structure of an attaching member for an interior lamp in the cooking apparatus according to the first embodiment of the invention.

In FIG. 1, a cooking apparatus 1 includes: a cooking apparatus body 17 in which a heating chamber 10 having an opened front face is formed by partition; a door 11 for opening/closing a front opening of the heating chamber 10; and heating means (a magnetron: not shown) for heating an interior of the heating chamber 10.

An interior lamp window 12 is formed on a side wall surface in the heating chamber 10. The interior lamp window 12 is a light-transmitting opening portion formed by a plurality of small punch holes and is shielded by a translucent sheet (not shown) in order to prevent entry of hot air from the heating chamber or dirt scattered from an object to be heated.

The cooking apparatus 1 further includes, above the front opening of the heating chamber, an operation unit 14 for setting a heating condition and a display unit 15 for displaying various conditions set by the operation unit 14 or a remaining time. The condition set by the operation unit 14 is output as a signal to a control board 100 (a control unit).

In FIG. 2, an interior lamp 13 is fixed by an interior lamp attaching plate 18 in a space defined by the heating chamber 10 and an outer casing 16 such that a surface of the interior lamp 13 opposing the interior lamp window 12 is inclined, and is disposed in a dead angle position with respect to a visual direction from the front opening of the heating chamber 10.

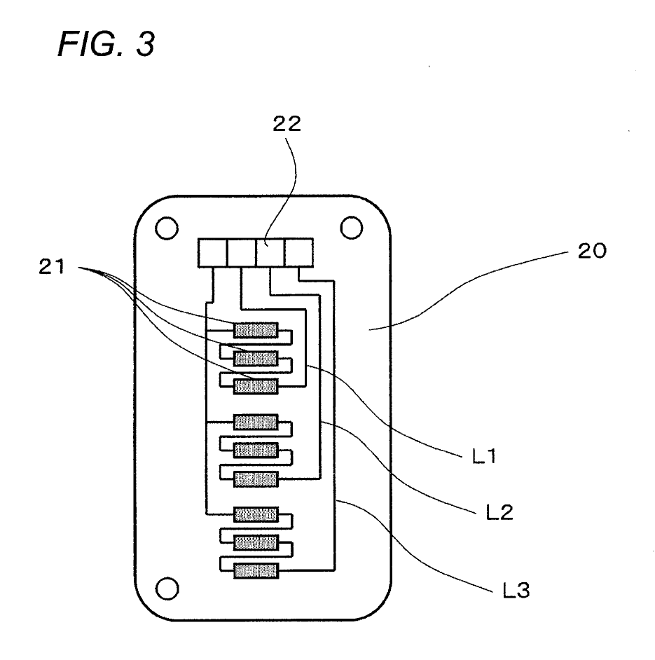

FIG. 3 is a schematic view showing a board on which an LED is mounted in the cooking apparatus according to the first embodiment of the invention.

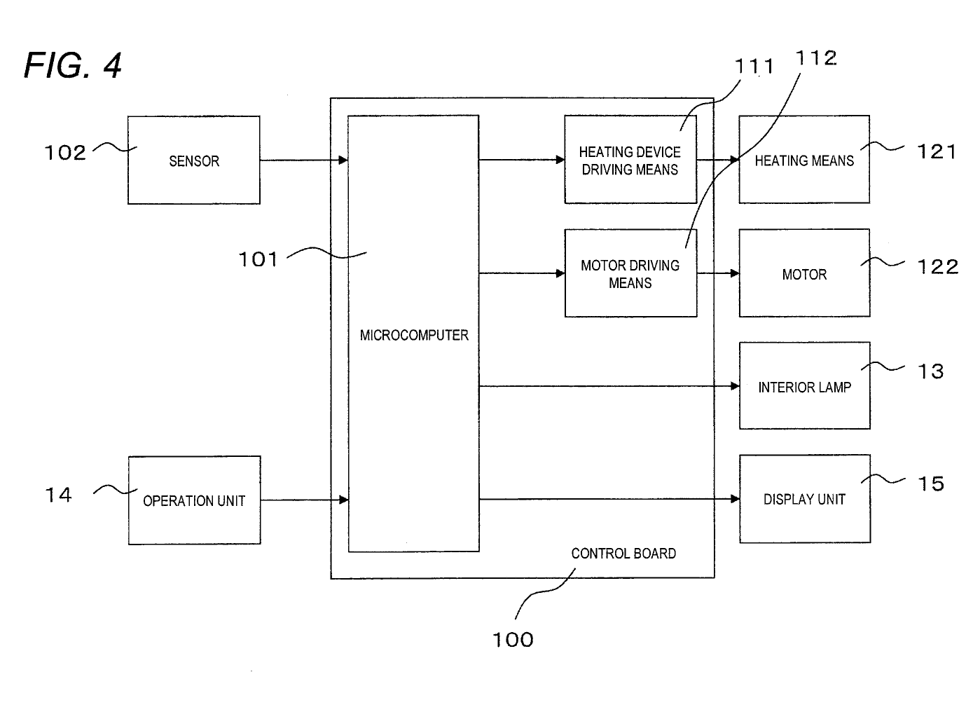

In FIG. 3, the interior lamp 13 includes a plurality of LED elements 21 (semiconductor light emitting device) which are mounted on an LED board 20. The LED elements 21 form cells, and circuits L1, L2, L3 in units of the cells are connected in parallel. Signals are transmitted to the control board 100 (see FIG. 4) through a connecting terminal 22.

Each of the cells is configured from the plurality of LEDs, whereby a light source of the cell is widened. Consequently, even when the LEDs having high directivity are used for the light source, the heating chamber is illuminated over a wide range, and it is possible to reduce unevenness of brightness in the heating chamber. Although the cell formed by the plurality of LED elements is described in the embodiment, the cell may be formed by a single LED depending on a characteristic of the LED such as luminance.

FIG. 4 is a block diagram showing the cooking apparatus according to the first embodiment of the invention.

In FIG. 4, a microcomputer 101 is mounted on the control board 100 and controls all functions related to the operation of the cooking apparatus. Moreover, heating device driving means 111 such as a relay and motor driving means 112 such as a triac is mounted on the control board 100.

The microcomputer 101 controls the heating device driving means 111 or the motor driving means 112 to drive heating means 121 or a motor 122 based on information input from the operation unit 14. Also, the microcomputer 101 performs driving control of the interior lamp 13 or the display unit 15 by directly supplies power thereto. Further, in order to perform optimum cooking based on information transmitted from a sensor 102, the microcomputer 101 controls strength or a drive time of the heating device driving means 111, or displays an error on the display unit 15 and stops the heating means 121 when a danger is detected.

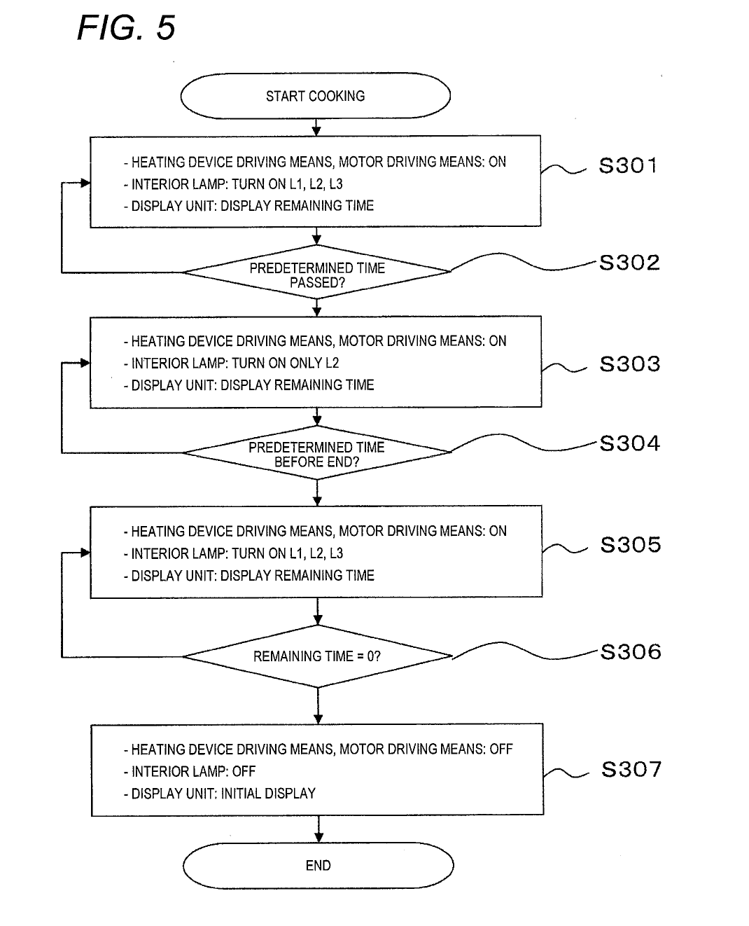

FIG. 5 is a flowchart showing the simplest cooking of the cooking apparatus according to the first embodiment of the invention.

In FIG. 5, when cooking start is input by the operation unit 14, control of the heating device driving means 111 and the motor driving means 112 is started and supply of power to the heating means 121 and the motor 122 are turned ON.

Control of the interior lamp 13 is also started so as to supply the power to L1, L2, L3, and information during the cooking such as a remaining time is disclosed in the display unit 15 (S301).

When a predetermined time passes (S302), the control of the interior lamp 13 is changed to supply the power to only L2, and the information during the cooking such as a remaining time is disclosed in the display unit 15 (S303).

Consequently, it is possible to reduce the power to be supplied to the interior lamp 13, thereby obtaining higher energy reduction performance. In the embodiment, for the control of the interior lamp 13 after the passage of the predetermined time, a configuration to supply the power to only L2 is described. However, a cell to be turned ON may be set arbitrarily, and a plurality of cells may be turned ON.

Further, the operation unit 14 includes a dedicated key for operating the interior lamp 13. When checking a cooking condition in the middle of the cooking, the user can change brightness in the cooking chamber by operating the dedicated key.

When the remaining time is a predetermined time set in advance before the end (S304), the control of the interior lamp 13 is changed so as to supply the power to L1, L2, L3, and the user is notified that the cooking will end soon (S305).

When the remaining time is zero (S306), the heating device driving means 111 and the motor driving means 112 are stopped, the interior lamp 13 is turned OFF, and a notification of the end of the cooking is given by a buzzer (not shown), whereby the cooking is ended.

The application is based on Japanese Patent Application (No. 2011-225581) filed on Oct. 13, 2011 and contents thereof are incorporated herein by reference.

### INDUSTRIAL APPLICABILITY

As described above, in the cooking apparatus according to the invention, an LED having a long life and small electric power consumption is used as an interior lamp and different lighting control of the LED is performed such that the lighting control at start and end of cooking is different from that in the middle of the cooking. Consequently, it is possible to reduce the electric power consumption in the middle of the cooking, thereby enhancing energy reduction performance. Since lighting time for the LED is also shortened, durability can also be improved. The present invention can be applied to a cooking apparatus for business purpose used by a user such as a convenience store, which is frequently used for heat cooking and which is required to have energy reduction performance and high durability.

### Description of Reference Signs

10 Heating Chamber

12 Interior Lamp Window

13 Interior Lamp

14 Operation Unit

20 LED Board

21 LED Element

100 Control Board (Control Unit)

1. A cooking apparatus comprising:
a heating chamber which accommodates an object to be heated;
an interior lamp which illuminates the heating chamber;
a control unit which controls the interior lamp; and
an operation unit which operates the control unit,
wherein the interior lamp is formed by a board on which a plurality of LED elements are mounted, and
wherein the control unit supplies power to only a part of the plurality of LED elements in a middle of the cooking.

2. The cooking apparatus according to claim 1,
wherein the control unit sets a number of the LED elements turning-ON in the interior lamp such that a number of turned-ON LED elements at time of the start and end of the cooking is different from that in the middle of the cooking.

3. The cooking apparatus according to claim 1,
wherein the operation unit comprises a dedicated key for operating the interior lamp, and
wherein brightness of the interior lamp can be freely changed when an interior of the heating chamber is to be checked.
